(19) United States
(12) Patent Application Publication
(10) Pub. No.: US 2015/0049643 A1
(43) Pub. Date: Feb. 19, 2015

(54) METHOD AND APPARATUS FOR PROVIDING DEFAULT SERVICES TO PROSPECTIVE SUBSCRIBERS IN A COMMUNICATION NETWORK

(71) Applicant: Alcatel-Lucent Canada Inc., Ottawa (CA)

(72) Inventors: Tiru K. Sheth, Ottawa (CA); Ramaswamy Subramanian, Ottawa (CA)

(73) Assignee: Alcatel-Lucent Canada Inc., Ottawa (CA)

(21) Appl. No.: 13/965,991

(22) Filed: Aug. 13, 2013

(51) Int. Cl. H04L 12/28; H04L 29/06

(52) U.S. Cl. CPC H04L 12/2858; H04L 63/10
USPC 370/255

(57) ABSTRACT

In one embodiment, a subscriber services controller comprises at least one processing device having a processor coupled to a memory. The subscriber services controller is configured to associate at least one default profile with an access node of a communication network, to detect an access attempt by a prospective subscriber via the access node, and responsive to the detected access attempt, to provide default services to the prospective subscriber via the access node in accordance with the default profile. The default profile may be provided to a broadband service aggregator associated with the access node in a set of authorization parameters. As a more particular example, the set of authorization parameters may be sent to the broadband service aggregator in a RADIUS-ACCESS-ACCEPT message from a RADIUS server, responsive to a successful authentication process performed in the RADIUS server.

### FIELD

The present invention relates generally to communication networks, and more particularly to techniques for providing services in such networks.

### BACKGROUND

In conventional communication networks, service providers configure their networks to provide appropriate services to subscribers. For example, many communication network subscribers receive a so-called “triple play” service package that includes a bundled combination of telephone, Internet and television services.

Service providers continually compete with one another for new subscribers. However, conventional communication networks are generally not configured to facilitate conversion of prospective subscribers into actual subscribers. Typically, a given prospective subscriber must directly contact the service provider and establish a subscriber account in order to receive the desired services. This conventional process can be unduly burdensome in many situations, such as when a prospective subscriber is moving into a new residence or business location, leading to possible loss of new subscribers for the service provider. Accordingly, techniques are needed that facilitate the conversion of prospective subscribers into actual subscribers.

### SUMMARY

Embodiments of the invention include methods and apparatus for providing default services to prospective subscribers in a communication network. Techniques implemented in one or more of these embodiments can overcome disadvantages associated with the conventional arrangements described above so as to facilitate the conversion of prospective subscribers to actual subscribers. For example, these techniques avoid the need for a prospective subscriber to establish a subscriber account with a service provider before receiving certain types of designated services upon moving into a new residence or business location.

In one embodiment, a subscriber services controller comprises at least one processing device having a processor coupled to a memory. The subscriber services controller is configured to associate at least one default profile with an access node of a communication network, to detect an access attempt by a prospective subscriber via the access node, and responsive to the detected access attempt, to provide default services to the prospective subscriber via the access node in accordance with the default profile.

A given default profile may comprise, for example, a default service level agreement and a default subscriber profile.

The default profile may be provided to a broadband service aggregator associated with the access node in a set of authorization parameters. As a more particular example, the set of authorization parameters may be sent to the broadband service aggregator in a RADIUS-ACCESS-ACCEPT message from a RADIUS server, responsive to a successful authentication process performed in the RADIUS server.

A wide variety of different types of default services provisioning can be implemented in embodiments of the invention. These include, for example, provision of default services for prospective subscribers based on access node name, provision of default services for prospective subscribers on preselected access node ports, and provision of default services for prospective subscribers using service provider certified gateways. Other related default services functionality includes denial of default services for prospective subscribers on preselected access node ports, and migration of default services for respective subscribers to personalized services.

Combinations of at least a subset of the above types of default services provisioning and one or more additional or alternative types of default services provisioning may be implemented in a given embodiment.

In some embodiments, default services provisioning functionality can be distributed over multiple processing platforms, each comprising one or more processing devices.

### BRIEF DESCRIPTION OF THE DRAWINGS

FIG. 1 shows a communication network having a subscriber services controller configured to provide default services to prospective subscribers in an illustrative embodiment.

FIG. 2 shows a more detailed view of the subscriber services controller of FIG. 1.

FIGS. 3 through 7 show examples of configuration displays generated by the subscriber services controller of FIG. 1.

FIG. 8 shows the operation of the FIG. 1 communication network in another illustrative embodiment.

### DETAILED DESCRIPTION

Illustrative embodiments of the invention will be described herein with reference to exemplary communication networks, processing platforms, processing devices and associated processes for providing default services to prospective subscribers. It should be understood, however, that the invention is not limited to use with the particular networks, platforms, devices and processes described, but is instead more generally applicable to any communication network application in which it is desirable to facilitate provision of default services in the network.

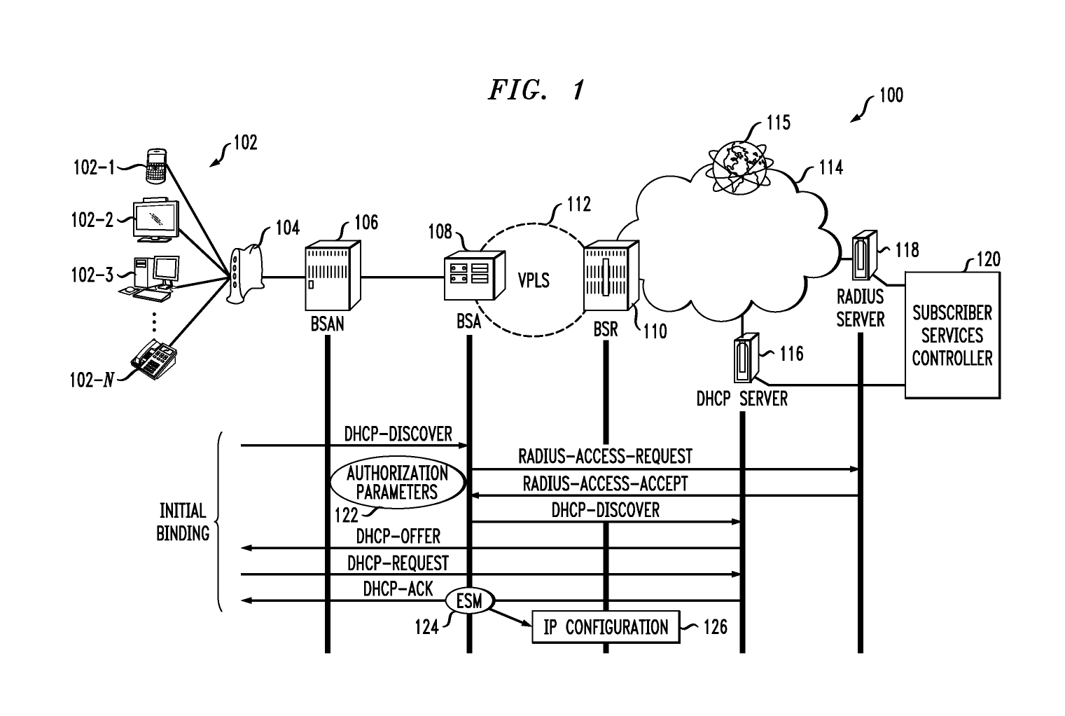

FIG. 1 shows a communication network 100 comprising a plurality of user devices 102 including a mobile telephone 102-1, a television and set-top box 102-2, a personal computer 102-3 and a telephone set 102-N. These user devices in some embodiments may be associated with a single residential or business location served by a gateway 104 which may comprise a residential or business gateway. The user devices 102 may comprise any combination of mobile telephones, laptop computers, desktop computers, tablet computers, set-top boxes, gaming consoles or any other devices that utilize communication services provided in the network 100.

It should be noted that the term “subscribers” as utilized herein is intended to be broadly construed, and may encompass, for example, customers or other users of the communication network 100. For example, subscribers may be users of particular data services provided by the communication network, such as triple play services comprising telephone, Internet and television services. As another example, subscribers may be respective businesses, organizations or other enterprises that utilize one or more services of the communication network 100. A given subscriber may be associated with all of the user devices 102 or different subscribers may be associated with respective different subsets of those user devices.

The user devices 102 communicate via the gateway 104 with a Broadband Services Access Node (BSAN) 106. The BSAN 106 may comprise an Intelligent Services Access Manager (ISAM), such as the ISAM products 7302, 7330, 7356, 7357 or 7360 commercially available from Alcatel-Lucent. The BSAN 106 is coupled to a Broadband Service Aggregator (BSA) 108. The BSA 108 communicates with a Base Station Router (BSR) 110 via a Virtual Private LAN Service (VPLS) 112. The BSR 110 is coupled to a backhaul network 114 that provides access to Internet 115, Dynamic Host Configuration Protocol (DHCP) server 116 and RADIUS server 118.

The operation of the DHCP server 116 is described in greater detail in Request for Comments (RFC) 2131 of the Internet Engineering Task Force (IETF). RFC 2131 and related RFCs 3315, 3396, 4361 and 5494 are incorporated by reference herein.

The RADIUS server 118 operates in accordance with the Remote Authentication Dial In User Service (RADIUS) protocol described in RFC 2865. RFC 2865 and related RFCs 2866, 2869, 3579 and 5080 are incorporated by reference herein. The RADIUS server is an example of what is more generally referred to herein as an “authentication server,” and other types of authentication servers may be used in other embodiments.

The servers 116 and 118 are coupled to a subscriber services controller (SSC) 120 that is configured to support provision of default services to prospective subscribers in a manner to be described in greater detail below. The SSC 120 may comprise, for example, an otherwise conventional SSC such as the Alcatel-Lucent 5750 SSC, suitably modified to incorporate default services provision functionality. Other types of SSCs may be used in other embodiments. In addition, although shown in the figure as being coupled only to the servers 116 and 118, the SSC 120 may be coupled to other network elements that are not expressly shown, such as additional DHCP and RADIUS servers or associated DHCP and RADIUS clients.

Also illustrated in FIG. 1 is a process for initial binding between the gateway 104 and the servers 116 and 118. When a given subscriber initially comes online to the network via one of the user devices 102 and gateway 104, a DHCP-DISCOVER message is generated and passed from the BSAN 106 to the BSA 108. The BSAN 106 inserts into this message a designated parameter representing a particular circuit on which the subscriber is coming online to the network. For example, this particular parameter may comprise an Option 82:1 string parameter, specifying Agent-Circuit-Id, although other types of strings and parameters may be used.

The BSA 108 generates a RADIUS-ACCESS-REQUEST message that includes the inserted string parameter and is sent via BSR 110 and backhaul network 114 to RADIUS server 118. In response to receipt of this message, the RADIUS server 118 attempts to authenticate the subscriber based on the inserted string parameter.

If the authentication is successful, the RADIUS server 118 retrieves authorization parameters 122 for the authenticated subscriber, and inserts those parameters into a RADIUS-ACCESS-ACCEPT message that is sent back to the BSA 108. The authorization parameters 122 may comprise, for example, a Service Level Agreement (SLA) profile and possibly one or more other subscriber profiles and subscriptions. Such profiles and subscriptions may include information such as Quality of Service parameters (QoS) specified for the authenticated subscriber.

The BSA 108 receives the authorization parameters 122 in the RADIUS-ACCESS-ACCEPT message and sends a DHCP-DISCOVER message to the DHCP server 116. This causes a DHCP-OFFER message to be sent by the DHCP server 116 to the gateway 104, which in turn responds back to the DHCP server with a DHCP-REQUEST message. The DHCP server 116 provides a DHCP-ACK message back to the gateway 104 via the BSA 108. An Enhanced Subscriber Management (ESM) element 124 extracts IP configuration information 126 from the DHCP-ACK message.

The above-described arrangement is modified in illustrative embodiments to support provision of default services to prospective subscribers. For example, as indicated previously, when a prospective subscriber is moving into a new residence or business location, the service provider may wish to provide that prospective subscriber with default services so as to increase the chances that the prospective subscriber will eventually become an actual subscriber.

In these and other situations, the new location may be pre-equipped with a gateway or the prospective subscriber may bring its own gateway and simply connect it to an access node connection provided at the new location. Accordingly, illustrative embodiments of the invention are configured to allow the prospective subscriber to receive default services in such situations. This advantageously avoids the need for a prospective subscriber to establish a subscriber account with a service provider before receiving certain services upon moving into a new residence or business location.

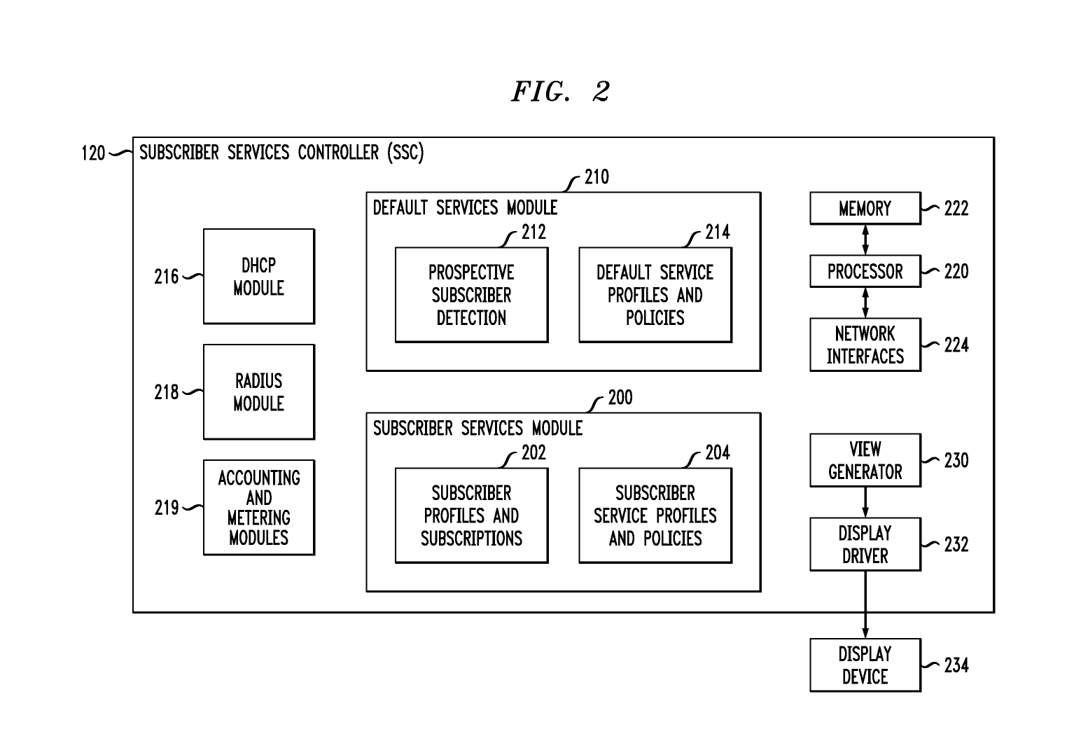

The manner in which the communication network 100 is configured to facilitate provision of default services to prospective subscribers will be described in greater detail below in conjunction with FIGS. 2 through 8.

It is to be appreciated that the particular arrangement of communication network 100 shown in FIG. 1 is presented by way of illustrative example only. The communication network 100 may more generally comprise any type of communication network suitable for transporting data or other signals, and embodiments of the invention are not limited in this regard. For example, portions of the communication network 100 may comprise a wide area network (WAN) such as the Internet, a metropolitan area network, a local area network (LAN), a cable network, a telephone network, a satellite network, as well as portions or combinations of these or other networks. The term “network” as used herein is therefore intended to be broadly construed. A given network may comprise, for example, routers, switches, servers, computers, terminals, nodes or other processing devices, in any combination.

The communication network 100 is implemented at least in part using one or more processing platforms. One or more of the processing modules or other components of communication system 100 may therefore each run on a computer, server, storage device or other processing platform element. A given such element may be viewed as an example of what is more generally referred to herein as a “processing device.” Such a device generally comprises a processor coupled to a memory and further includes at least one network interface.

The communication network 100 may include additional or alternative processing platforms, as well as numerous distinct processing platforms in any combination, with each such platform comprising one or more computers, servers, storage devices or other processing devices.

Multiple elements of communication network 100 may be collectively implemented on a common processing platform, or each such element may be implemented on a separate processing platform.

Also, embodiments of the present invention may be implemented at least in part in the form of one or more software programs that are stored in a memory or other computer-readable storage medium of a network device or other processing device of the communication network 100.

Referring now to FIG. 2, an illustrative embodiment of the SSC 120 is shown in great detail. In this embodiment, the SSC 120 comprises a subscriber services module 200 that includes subscriber profiles and subscriptions 202 and subscriber service profiles and policies 204. This module is utilized in configuring the network 100 to provide services to actual subscribers, such as those subscribers that have previously established a subscriber account with the service provider. The SSC 120 further comprises a default services module 210 that includes a prospective subscriber detection module 212 and default service profiles and policies 214. This module is utilized in configuring the network 100 to provide default services to prospective subscribers, such as those subscribers that have not previously established a subscriber account with the service provider.

Also included in the SSC 120 is a DHCP module 216 and a RADIUS module 218. These modules are configured to interface with the respective DHCP server 116 and RADIUS server 118. The modules 216 and 218 are also assumed to be configured to provide interfaces with additional DHCP and RADIUS servers as well as associated DHCP and RADIUS clients.

The SSC 120 further comprises accounting and metering modules 219 that keep track of types and amounts of services utilized by actual and prospective subscribers in the communication network 100.

The SSC 120 in the present embodiment further comprises a processor 220 coupled to a memory 222.

The processor 220 may comprise, for example, a microprocessor, a microcontroller, an application-specific integrated circuit (ASIC), a field-programmable gate array (FPGA) or other type of processing circuitry, as well as portions or combinations of such circuitry elements.

The memory 222 may comprise, for example, an electronic random access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The processor 220 and memory 222 may be used in storage and execution of one or more software programs for directing the operation of the SSC 120. Accordingly, default services provision functionality associated with SSC 120 may be implemented at least in part using such software programs.

The memory 222 is configured to include one or more storage areas that may be utilized for program code storage. A given such memory may therefore be viewed as an example of what is more generally referred to herein as a computer program product or still more generally as a computer-readable storage medium that has executable program code embodied therein. Other examples of computer-readable storage media may include disks or other types of magnetic or optical media, in any combination. Articles of manufacture comprising such computer-readable storage media are considered embodiments of the invention.

Also included in the SSC 120 are multiple network interfaces 224. The network interfaces are used to support communication between the SSC 120 and other system components, such as DHCP and RADIUS servers 116 and 118, and may comprise conventional transceivers or other types of network interface circuitry.

The processor 220, memory 222 and network interfaces 224 may include well-known circuitry suitably modified to implement at least a portion of the default services provision functionality described above. Conventional aspects of such circuitry are well known to those skilled in the art and therefore will not be described in detail herein.

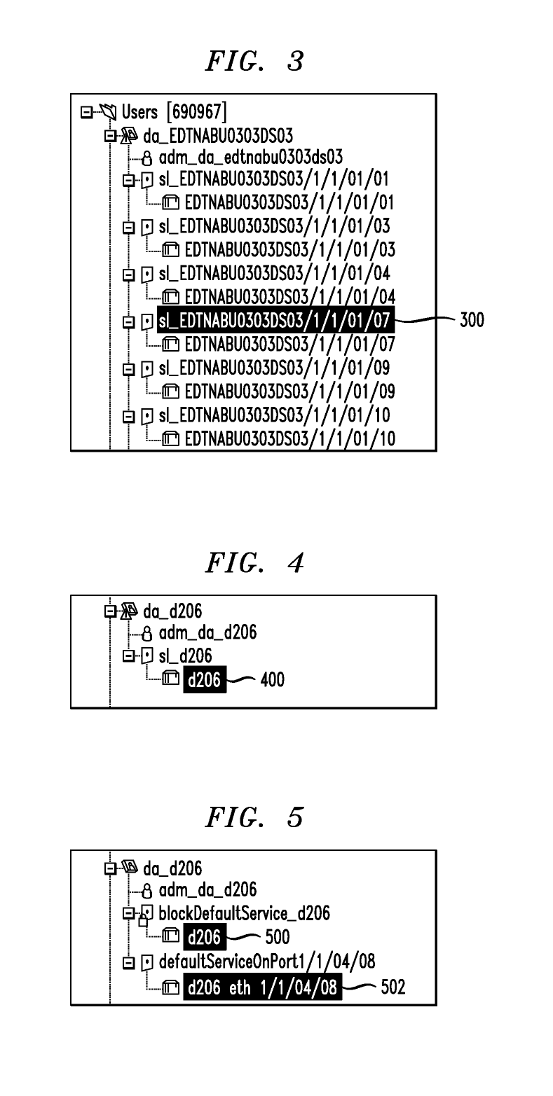

The SSC 120 further comprises a view generator 230 that is coupled via a display driver 232 to an external display device 234. The external display device 234 may comprise a conventional computer monitor or other type of display device suitable for presenting various views generated by the view generator 230. Such views include, for example, various configuration displays that will be described below in conjunction with FIGS. 3 through 7.

It is to be appreciated that a given subscriber services controller as disclosed herein may be implemented using additional or alternative components and modules other than those specifically shown in the exemplary arrangement of FIG. 2. Also, a communication network such as network 100 may comprise multiple such subscriber services controllers, rather than a single controller as shown in FIG. 1.

The SSC 120 may be implemented using one or more processing platforms, each comprising at least one processing device.

A wide variety of different types of default services provision functionality may be implemented in communication network 100 utilizing the SSC 120. These include, for example, provision of default services for prospective subscribers based on access node name, provision of default services for prospective subscribers on preselected access node ports, and provision of default services for prospective subscribers using service provider certified gateways. Other related default services functionality that may be implemented in communication network 100 includes denial of default services for prospective subscribers on preselected access node ports, and migration of default services for respective subscribers to personalized services.

FIG. 3 shows a configuration display generated by the SSC 120 for presentation on display device 234 in the case of actual subscribers. In order for a RADIUS server to authenticate a subscriber in the manner described in conjunction with FIG. 1, all of the circuits available in the access node generally have to be modeled as respective subscribers in a database accessible to the server. This typically involves configuring an SLA profile and possibly one or more other subscriber profiles and subscriptions for every circuit, resulting in a configuration display of the type shown in FIG. 3.

The configuration display of FIG. 3 is therefore generated in accordance with a model suitable for providing individualized services for every subscriber on every circuit. The highlighted entry 300 is of the form:
<SubscriberLineName>/<rack>/<shelf>/<slot>/<port>,
   and more specifically denotes a particular circuit comprising a subscriber line on an access node identified as EDTNABU0303DS03, with the particular circuit being on port 7 of slot 1 on shelf 1 of rack 1 of the access node. Every circuit available on the access node is modeled in substantially the same way.

The model utilized for the configuration display of FIG. 3 is generally not well suited for use in the provision of default services. For example, use of the model associated with the FIG. 3 configuration display can lead to excessive overhead because it requires that every circuit available in the access node be modeled in the database. Also, assigning default profiles for all the circuits would involve configuring all the circuits available in the access node. This would create additional difficulties in terms of maintaining consistency among all of the access node circuits. It also fills the database with default profiles that do not represent actual subscribers.

FIG. 4 shows an alternative configuration display generated in accordance with a modified model based on access node name. This model does not require all of the circuits available in the access node to be modeled as individual subscribers in the database and therefore facilitates provision of default services for prospective subscribers based on access node.

In the configuration display of FIG. 4, d206 is the name of a particular access node, da_d206 is an account on access node d206, adm_da_d206 is an administrative user for this account, and sl_d206 is a default subscriber line to which a default SLA profile and a default subscriber profile are configured. The highlighted entry 400 denotes a default logical circuit representing all of the circuits available in the access node.

The previously-described authentication process performed by the RADIUS server 118 is then modified as follows:

1. Authenticate based on the circuit received in an ACCESS-REQUEST message. As noted above, the circuit may be identified in an Option 82:1 string parameter, specifying Agent-Circuit-Id.

2. If the authentication based on the circuit fails, determine the access node name using the Agent-Circuit-Id parameter and authenticate based on the access node name.

3. If the authentication based on the access node name fails, send an ACCESS-REJECT message.

4. If the authentication based on the access node name is successful, fetch the SLA profile and subscriber profile configured for the default subscriber line using the default logical circuit.

5. Send these parameters in an ACCESS-ACCEPT message.

The provision of default services to prospective subscribers based on access node name as described above can be applied to a wide variety of different access node types and associated formats, including the following:
<NodeName><rack>/<shelf>/<slot>/<port>
<NodeName>.<slot>.<port>
<NodeName> PON <rack>/<shelf>/<LT card slot>/<PON port number>:<ont number on PON>.<ont card slot number>.<ont port number>
<NodeName>-<InterfaceTypeSlot/port>
<NodeName>_<vlan>

This embodiment in which default services are provided based on access node name removes the need for configuring every circuit of the access node, thereby eliminating a significant amount of configuration overhead relative to the model utilized for the configuration display of FIG. 3. Also, it allows each access node to be configured with different default SLA and subscriber profiles.

As noted above, the SSC 120 can also be configured to provide default services for prospective subscribers on preselected access node ports. In such an embodiment, the service provider determines that it will provide default services only on certain access node ports for various reasons. For example, an Alcatel-Lucent ISAM of the type mentioned previously herein may have 192 ports, and a service provider may decide to default services on only a particular port, such as port 1/1/04/08 in <rack>/<shelf>/<slot>/<port> format, and block default services on all other ports.

FIG. 5 shows a configuration display generated in accordance with a model that allows provision of default services only on preselected access node ports.

In the configuration display of FIG. 5, d206 is the name of a particular access node, da_d206 is an account on access node d206, adm_da_d206 is an administrative user for this account, and blockDefaultService_d206 is a subscriber line which is suspended to block default services. The highlighted entry 500 denotes a default logical circuit representing all of the circuits available in the access node.

A new subscriber line for the port on which the default service will be provided is also modeled in the database, as entry defaultServiceOnPort1/1/04/08. This entry permits default service to be provided only on port 1/1/04/08. The default SLA profile and default subscriber profile are configured for the new subscriber line and set to an active status. The Agent-Circuit-Id for any subscribers coming online on this port will have a value of d206 eth 1/1/04/08 as indicated in highlighted entry 502. This is modelled as a circuit for the defaultServiceOnPort1/1/04/08 subscriber line.

The authentication process performed by the RADIUS server 118 in this embodiment is as follows:

1. Authenticate based on the circuit received in an ACCESS-REQUEST message. As noted above, the circuit may be identified in an Option 82:1 string parameter, specifying Agent-Circuit-Id.
a. If the authentication based on the circuit is successful, fetch the subscriber line using this circuit.
b. If the subscriber line status is suspended or blocked, respond with an ACCESS-REJECT message.
c. If the subscriber line status is active, fetch the default SLA profile and subscriber profile configured for this subscriber line.
d. Send these parameters in an ACCESS-ACCEPT message.

2. If the authentication based on the circuit fails, determine the access node name using the Agent-Circuit-Id parameter and authenticate based on the access node name.
a. If the authentication based on the access node name fails, send an ACCESS-REJECT message.
b. If the authentication based on the access node name is successful, fetch the subscriber line using the default logical circuit associated with the access node name.
c. If the subscriber line status is suspended or blocked, respond with an ACCESS-REJECT message.
d. If the subscriber line status is active, fetch the SLA profile and subscriber profile configured for the default subscriber line using the default logical circuit.
e. Send these parameters in an ACCESS-ACCEPT message.

In accordance with the above procedure, and assuming use of the configuration display of FIG. 5, a subscriber coming online on port 1/1/04/08 will be able receive the default services as the circuit is modeled in the database and the subscriber line associated with this circuit has an active status. However, for all other ports, the default circuit identified by d206 will be used for authentication. The authentication will succeed, but the subscriber line associated with this circuit is suspended and so an ACCESS-REJECT message will be sent to block access to services.

Although only a single port is preselected to support provision of default services in the FIG. 5 embodiment, additional access node ports can be preselected to support provision of default services in a similar manner.

This embodiment in which default services are provided only on one or more preselected access node ports gives the service provider full control to determine the list of ports on which default services should be provided. Such an embodiment is particularly advantageous in communication networks in which an access node is used to support a neighborhood or other geographic region where default services are only to be provided to a portion of the neighborhood or other region.

As mentioned previously, the SSC 120 can additionally or alternatively be configured to provide default services for prospective subscribers using service provider certified gateways. In such an embodiment, a given service provider determines that it will provide default services only for those prospective subscribers that are accessing the network via particular types of gateways, such as gateways from a particular vendor or vendors, and deny default services to those prospective subscribers that are using unsupported gateways. This can be accomplished using the model illustrated by the configuration display of FIG. 4 in conjunction with specification of an access request policy having a set of one or more rules. This set of rules is executed before proceeding to the authentication.

An exemplary format for a given one of the rules of a particular access request policy is as follows:
<Attribute><Condition><Value><Action>
   In this format, the <Attribute> field represents any attribute that may be received in an ACCESS REQUEST message, such as RFC 2138 attributes or RADIUS dictionary attributes. The <Condition> field may include one or more specified conditions such as Equals, Matches, StartsWith, EndsWith, Contains, RegExp, GreaterThan, LessThan, Between or Appears. The <Value> field specifies a designated value that is associated with the condition, and the <Action> field can be SendReject or PerformAuthentication. This particular format is exemplary only, and other rules formats can be used.

The authentication process performed by the RADIUS server 118 in this embodiment is as follows:

1. Preprocess the ACCESS-REQUEST message to determine if the access request policy indicates that authentication should be performed.

2. If the access request policy indicates that authentication should not be performed, send an ACCESS-REJECT message.

3. If the access request policy indicates that authentication should be performed, authenticate based on the circuit received in an ACCESS-REQUEST message. As noted above, the circuit may be identified in an Option 82:1 string parameter, specifying Agent-Circuit-Id.

4. If the authentication based on the circuit fails, determine the access node name using the Agent-Circuit-Id parameter and authenticate based on the access node name.

5. If the authentication based on the access node name fails, send an ACCESS-REJECT message.

6. If the authentication based on the access node name is successful, fetch the SLA profile and subscriber profile configured for the default subscriber line using the default logical circuit.

7. Send these parameters in an ACCESS-ACCEPT message.

As one example of an implementation of this embodiment, assume that a service provider would like to deny default services to prospective subscribers that attempt to access the network using two-wire gateways. A rule can be defined in the access request policy as follows:
Client-Hardware-Addr StartsWith 00:18:3f SendReject
   where 00:18:3f denotes a starting portion of a MAC address specified as an attribute in the access request policy rule. The RADIUS server 118 preprocesses the ACCESS-REQUEST message, and if it determines that the MAC address starts with 00:18:3f, the request is rejected and default services will not be provided to the subscriber. However, if it determines that the MAC address does not start with 00:18:3f, the RADIUS server will proceed with the authentication process in the manner described above.

This embodiment in which default services are provided only for prospective subscribers using service provider certified gateways ensures service provider control of the gateways connected to the network. For example, it allows the service provider to assess the various gateways in the market and ensures that only those gateways certified by the service provider are made available to its prospective subscribers. Also, use of only service provider certified gateways tends to reduce the number of service calls that might otherwise be required to troubleshoot connectivity or service related issues.

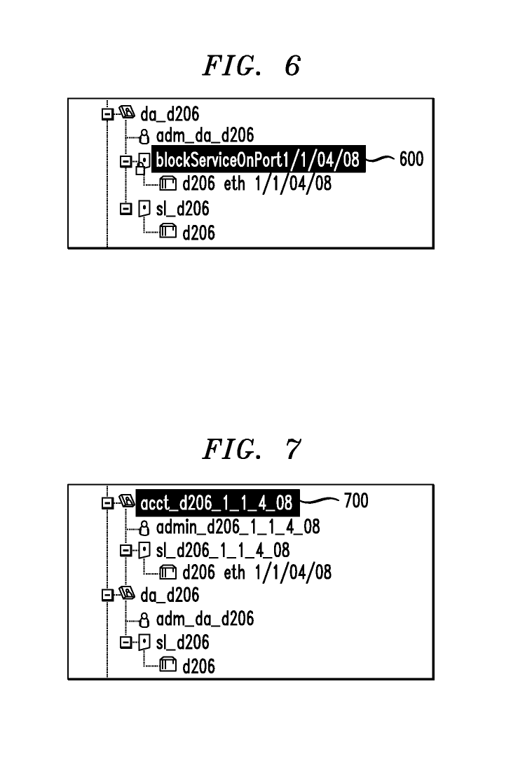

It was indicated above that the SSC 120 may additionally or alternatively implement denial of default services for prospective subscribers on preselected access node ports. This can be implemented in a manner similar to that previously described in the context of the embodiment of FIG. 5. The configuration display of FIG. 6 includes a highlighted entry 600 denoted blockServiceOnPort 1/1/04/08 that illustratively denies default services on this access node port, while allowing provision of default services on all other ports associated with access node d206. The subscriber line status for entry 600 is set to suspended in order to block the default services for port 1/1/04/08.

Such an arrangement can be particularly useful in situations in which a prospective subscriber has been using default services on a certain port but has not signed up as an actual subscriber within a specified trial period. This embodiment allows the service provider to suspend the default services on the port in this circumstance. The authentication process performed by the RADIUS server 118 in this embodiment is substantially the same as that previously described for the FIG. 5 embodiment.

In one or more of the above-described illustrative embodiments, a given prospective subscriber provided with default services may decide to become an actual subscriber of the service provider. This may involve, for example, the prospective subscriber establishing an account with the service provider to receive personalized services within the communication network 100. In these and other situations, the SSC 120 is configured to migrate default services for a given prospective subscriber to personalized services for that subscriber as an actual subscriber.

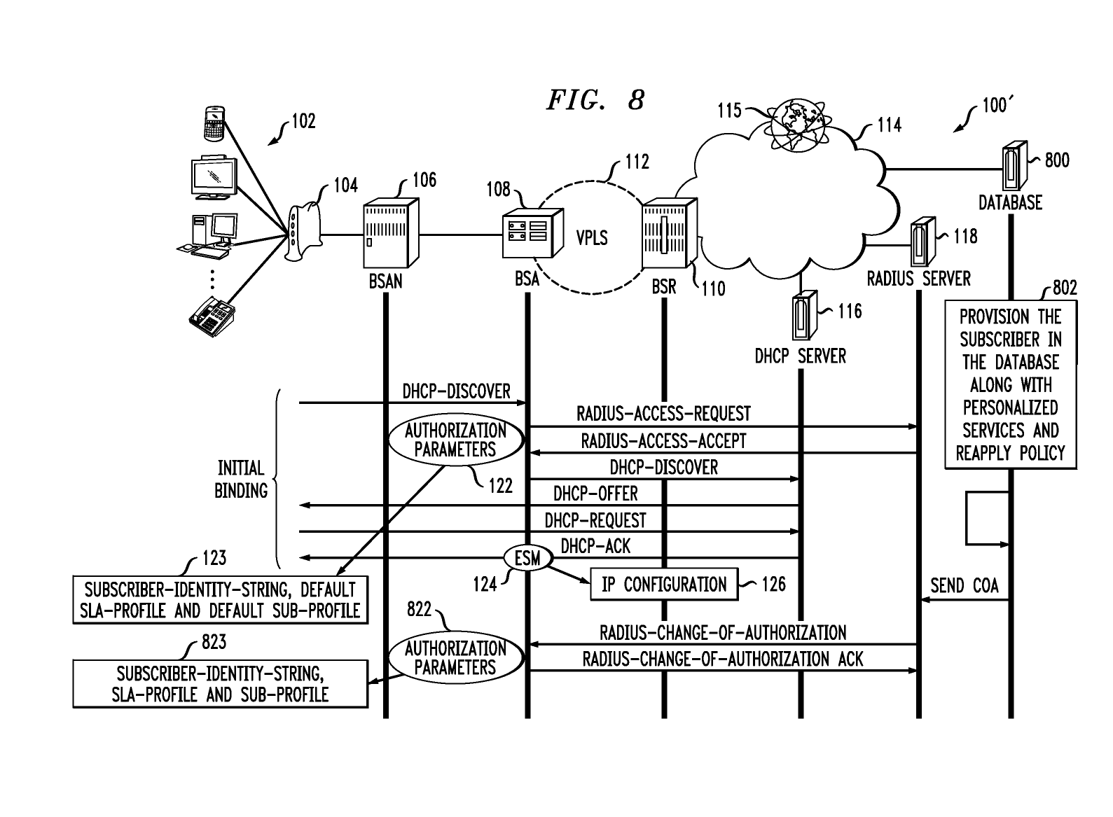

The lower portion of the configuration display of FIG. 7 includes the configuration display previously described in conjunction with FIG. 4. This lower portion of the configuration display permits default services to be provided to a prospective subscriber based on access node name in the manner outlined above.

In the upper portion of the FIG. 7 configuration display, an account is established for that subscriber such that the subscriber becomes an actual subscriber. This involves configuring the new account and an associated subscriber line and set of subscribed services in the SSC 120. The account established for the subscriber is denoted acct d206_{—}1_{—}1_{—}4_{—}08 and is shown in highlighted entry 700. Also indicated in the upper portion of the FIG. 7 configuration display is the administrative user admin_d206_{—}1_{—}1_{—}4_{—}08 for the subscriber account, and the corresponding subcriber line sl_d206_{—}1_{—}1_{—}4_{—}08 using the circuit denoted d206 eth 1/1/04/08.

FIG. 8 illustrates the provision process for the new account. The figure shows a communication network 100′ that includes elements 102, 104, 106, 108, 110, 112, 114, 115, 116 and 118 as described previously in conjunction with FIG. 1. Also shown in the figure is an initial binding process that is substantially the same as that described previously. However, in this embodiment, authorization parameters 122 are illustrated as more particularly comprising a set of information 123 comprising a subscriber identity string, a default SLA profile and a default subscriber profile in accordance with the provision of default services to a prospective subscriber.

The communication network 100′ further comprises a database 800. Although not expressly shown in this figure, the SSC 120 is also assumed to be present, and coupled to the DHCP server 116, RADIUS server 118 and database 800.

As indicated in box 802, the new subscriber is provisioned in the database 800 along with corresponding personalized services. This involves generating the configuration information in the format shown in the upper portion of the FIG. 7 configuration display, and then executing a reapply policy operation. The latter operation causes a Change of Authorization (COA) message to be sent from the database 800 or the associated SSC 120 to the RADIUS server 118 as indicated. The RADIUS server 118 in turn sends a RADIUS-CHANGE-OF-AUTHORIZATION message to the BSA 108 with a new set of authorization parameters 822. The BSA replies with a corresponding acknowledgment back to the RADIUS server 118. The new set of authorization parameters 822 includes a set of information 823 comprising a subscriber identity string, a personlized SLA profile and a personalized subscriber profile in accordance with the provision of personalized services to an actual subscriber.

This embodiment ensures that migration from provision of default services for a prospective subscriber to provision of personalized services for that subscriber as an actual subscriber will happen seamlessly without any service interruptions.

As mentioned above, embodiments of the present invention may be implemented in the form of articles of manufacture each comprising one or more software programs that are executed by processing circuitry of a processing device of a communication network.

Also, embodiments of the present invention may be implemented in one or more ASICS, FPGAs or other types of integrated circuit devices, in any combination. Such integrated circuit devices, as well as portions or combinations thereof, are examples of “circuitry” as that term is used herein.

A wide variety of other arrangements of hardware and associated software or firmware may be used in implementing embodiments of the invention.

As another example, embodiments of the invention can be implemented using processing platforms that include cloud infrastructure or other types of virtual infrastructure. Such virtual infrastructure generally comprises one or more virtual machines and at least one associated hypervisor running on underlying physical infrastructure.

Also, although certain illustrative embodiments are described herein in the context of particular communication protocols such as IP, DHCP and RADIUS, other types of protocols can be used in other embodiments.

It should again be emphasized that the embodiments described above are for purposes of illustration only, and should not be interpreted as limiting in any way. Other embodiments may use different types of communication networks, processing platforms and devices, and processes for providing default services, depending on the needs of a particular implementation. Alternative embodiments may therefore utilize the techniques described herein in other contexts in which it is desirable to provide users with communication services. Also, the various assumptions made herein in conjunction with the description of certain embodiment need not apply in other embodiments. These and numerous other alternative embodiments within the scope of the appended claims will be readily apparent to those skilled in the art.

What is claimed is:

1. A method comprising:
associating at least one default profile with an access node of a communication network;
detecting an access attempt by a prospective subscriber via the access node; and
responsive to the detected access attempt, providing default services to the prospective subscriber via the access node in accordance with the default profile;
wherein the associating, detecting and providing are performed by at least one processing platform comprising one or more processing devices.

2. The method of claim 1 wherein the associating, detecting and providing are performed under the control of a subscriber services controller implemented on said at least one processing platform.

3. The method of claim 1 wherein said at least one default profile comprises a default service level agreement and a default subscriber profile.

4. The method of claim 1 wherein providing default services to the prospective subscriber via the access node in accordance with the default profile comprises providing the default profile to a broadband service aggregator associated with the access node in a set of authorization parameters.

5. The method of claim 4 wherein the set of authorization parameters is sent to the broadband service aggregator in a RADIUS-ACCESS-ACCEPT message from a RADIUS server.

6. The method of claim 5 wherein the set of authorization parameters is sent responsive to a successful authentication process performed in the RADIUS server.

7. The method of claim 1 further comprising designating one or more ports of the access node over which default services will be provided to prospective subscribers, wherein access attempts arriving via other ports of the access node are automatically denied default services.

8. The method of claim 1 further comprising designating one or more ports of the access node over which default services will be denied to prospective subscribers, wherein access attempts arriving via other ports of the access node are automatically provided with default services.

9. The method of claim 1 wherein providing default services to the prospective subscriber via the access node in accordance with the default profile comprises providing the default services only if the access attempt is first determined to satisfy a specified access request policy.

10. The method of claim 9 wherein the access request policy comprises one or more rules of the form:
<Attribute><Condition><Value><Action>,
wherein <Attribute> denotes an attribute of an access request message associated with the access attempt, <Condition> denotes a conditional operator, <Value> specifies a designated value that is associated with the condition, and <Action> includes one of reject request and perform authentication.

11. The method of claim 9 wherein the access request policy specifies that the access attempt must be received via a designated type of gateway in order for default services to be provided.

12. The method of claim 1 further comprising migrating the default services for the prospective subscriber to personalized services for an actual subscriber.

13. The method of claim 12 wherein migrating the default services for the prospective subscriber to personalized services for an actual subscriber comprises providing a personalized profile to a broadband service aggregator associated with the access node in a set of authorization parameters.

14. The method of claim 13 wherein the set of authorization parameters is sent to the broadband service aggregator in a RADIUS-CHANGE-OF-AUTHORIZATION message from a RADIUS server.

15. An article of manufacture comprising a computer-readable storage medium having embodied therein program code that when executed by at least one processing platform causes said processing platform to:
associate at least one default profile with an access node of a communication network;
detect an access attempt by a prospective subscriber via the access node; and
responsive to the detected access attempt, provide default services to the prospective subscriber via the access node in accordance with the default profile.

16. An apparatus comprising:
a subscriber services controller comprising at least one processing device having a processor coupled to a memory;
wherein the subscriber services controller is configured to associate at least one default profile with an access node of a communication network, to detect an access attempt by a prospective subscriber via the access node, and responsive to the detected access attempt, to provide default services to the prospective subscriber via the access node in accordance with the default profile.

17. The apparatus of claim 16 wherein said subscriber services controller comprises:
a default services module configured to control provision of the default services to the prospective subscriber; and
a subscriber services module configured to provide personalized services to at least one actual subscriber.

18. A communication network comprising:
a subscriber services controller;
an authentication server coupled to the subscriber services controller; and
an access node configured for communication with the authentication server;
wherein the subscriber services controller is configured to associate at least one default profile with the access node, to detect an access attempt by a prospective subscriber via the access node, and responsive to the detected access attempt, to provide default services to the prospective subscriber via the access node in accordance with the default profile.

19. The network of claim 18 wherein the authentication server comprises a RADIUS server.

20. The network of claim 18 further comprising a broadband service aggregator coupled between the authentication server and the access node, the broadband service aggregator receiving the default profile from the authentication server in one or more messages comprising a set of authorization parameters.
